(19) United States
(12) Patent Application Publication
(10) Pub. No.: US 2006/0118097 A1
(43) Pub. Date: Jun. 8, 2006

(54) Diamond wheel and scribing device

(76) Inventor: Hirokazu Ishikawa, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/560,034

(22) PCT Filed: Jun. 3, 2004
(86) PCT No.: PCT/JP04/07684

§ 371 Date: Dec. 8, 2005

(30) Foreign Application Priority Data
Jun. 12, 2003 (JP) 2003-167236

(51) Int. Cl. B28D 1/04

(52) U.S. Cl. 125/13.01

(57) ABSTRACT

There is provided a diamond wheel rolling on the surface of a brittle material without sliding thereon and hardly forming horizontal cracks.

A diamond wheel 8 forms a scribe line on the surface of the brittle material while rolling thereon. In this diamond wheel, diamond grains 15, 15,—of 1000 to 8000 mesh are carried by a bonding agent. The diamond grains projecting from the bonding agent 16 easily bite the brittle material, so that the diamond wheel can roll on the brittle material without sliding even in no application of load more than necessary.

### TECHNICAL FIELD

The present invention relates to a diamond wheel and a scribing apparatus adapted to form a scribe line on glass, quartz, liquid-crystal or corundum-type brittle material, or the like.

### Background Art

In order to cut off a brittle material at a predetermined size, there is adopted a method of forming a scribe line on a surface of the brittle material, then applying a pressure and cracking the same. It is general, in order to form the scribe line on the surface of the brittle material, to roll a wheel having an abrasive grain layer at a peripheral portion of a metallic rootstock on the surface of the brittle material. A wheel having an abrasive grain layer which holds diamond grains with a bonding agent is called “diamond wheel”.

In an event that the diamond wheel rolls on the brittle material in a state that the diamond wheel slightly sticks the brittle material, that is, the diamond wheel bites the brittle material, a scribe line is formed on the surface of the brittle material. The scribe line is one formed from continuous vertical cracks, and by applying a pressure to the brittle material on which the scribe line is formed, the brittle material is cut off.

If the diamond wheel slides on the surface of the brittle material without biting the same, crack will be likely caused along the scribe line on the surface of the brittle material as if glass is cut by a glass cutter. In order to make the diamond wheel bite the brittle material, diamond grain having a large Knoop hardness difference with respect to the brittle material will be utilized as abrasive grain.

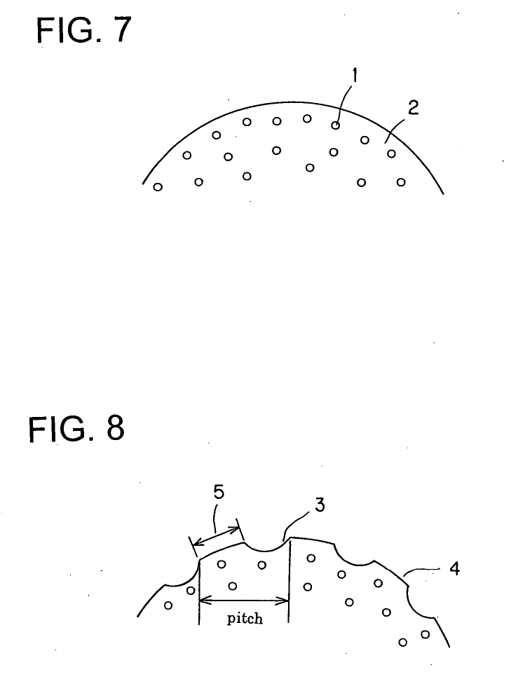

In a conventional art, as shown in FIG. 7, there is utilized a diamond wheel, in which diamond powders 1, 1,—having average grain diameter of 0.1 to 0.8 μm (extremely fine powders exceeding mesh 10000) are carried by a bonding agent 2, as a diamond wheel for forming a scribe line on the surface of a brilliant material.

Furthermore, as another diamond wheel for cutting a glass plate, there is known one disclosed in the following Patent Publication 1 in which a V-shaped blade is formed on a peripheral portion of a disc. As shown in FIG. 8, notches 3 are formed with a pitch of 20 to 30 μm in a circumferential direction of the blade edge of the peripheral portion of the diamond wheel by cutting it with a grinder or by electric discharge machining. At the time when the diamond wheel rolls on the glass plate, projections 4 strike the glass plate surface to thereby form deep vertical cracks in the glass plate which may penetrate the glass plate.

Patent Publication 1: Japanese Patent Laid-opn Publication No. HEI 9-188534

### DISCLOSURE OF THE INVENTION

### Problems to be solved by The Invention

However, in the conventional diamond wheel, in which the extremely fine diamond powders, having average grain diameter of 0.1 to 0.8 μm, are carried by the bonding agent, since the diamond powders are buried at almost all part in the bonding agent, the diamond powder projects over the surface of the bonding agent only by the amount of ⅓ to ⅕ of its diameter. When such diamond powders are used as grinding grains, a biting amount of the diamond powder becomes small, so that it is necessary to add a large load to the diamond wheel so as not to slide. If making large the load, chippings, i.e., horizontal cracks, may be generated on the surface of the brittle material, thus degrading the quality of the brittle material.

Moreover, even if the diamond wheel disclosed in the above Patent Publication 1 be used, chippings, i.e., horizontal cracks, are still generated on the surface of the brittle material. This seems to be a result that a pitch between notches 3, 3 is not made small by forming the notch to the blade edge in a post-working. In order that a crest 5, having a certain width, formed between the notches 3 and 3, bites the glass plate, some amount of load is needed, by which it seems that the chipping is generated.

An object of the present invention is to solve problems encountered in the conventional art mentioned above and to provide a diamond wheel and a scribing apparatus which roll on the surface of a brittle material, without sliding thereon, and hardly generate horizontal cracks.

### Means for Solving the Problems

In order to solve the above problems, the inventor of the subject application had eyes on a diameter of a diamond grain and used a diamond grain having a grain diameter larger than that of conventional diamond grain so that the diamond grains can easily project from a bonding agent.

More specifically, the above object can be achieved by providing a diamond wheel for forming a scribe line on a surface of a brittle material while rolling thereon, wherein diamond grains having 1000 to 8000 mesh are held by a bonding agent.

According to this invention, since the diamond grain projecting from the bonding agent easily bites the brittle material, the diamond wheel can roll on the brittle material without sliding thereon without applying a load more than necessary. For this reason, horizontal cracks due to excessive load at the time of forming the scribe line to the brittle material are hardly generated. A stress to be applied to the brittle material from the diamond wheel corresponds to a stress concentrated in accordance with the size of the diamond grain projecting from the bonding agent, so that deep vertical cracks can be formed.

Further, the diamond grains may be only abrasive grains of 1000 to 8000 mesh or may be a mixture of the abrasive grains of 1000 to 8000 mesh and diamond powders.

It is desired that a blade a V-section is formed in an entire circumferential direction of a peripheral edge portion of the diamond wheel, a pitch of the diamond grains at a front end edge of the V-shaped blade in the circumferential direction is set to be 2 to 20 μm.

According to this invention, the pitch of the diamond grains is set to be short, so that the diamond grains projecting from the bonding agent are liable to easily bite the brittle material before the contacting of a recessed portion formed between the adjacent diamond grains to the surface of the brittle material. For this reason, the diamond wheel can roll on the surface of the brittle material without sliding thereon. In addition, although vertical cracks are generated when the diamond grains bite the brittle material, the vertical cracks easily propagate by setting the pitch of the diamond grains in the circumferential direction of the diamond wheel, thus forming a scribe line in good condition.

It is also desired that the V-shaped section has an opening angle of 110 to 165 degrees.

According to this invention, since the brittle material can be torn by a blade edge having a dull angle, the generation of the vertical crack is promoted.

It is further desired that the diamond wheel rolls on the brittle material while oscillating in a direction crossing the surface of the brittle material.

By applying the oscillation to the diamond wheel, further deep vertical cracks can be formed.

Furthermore, the present invention may further provide a scribing apparatus for forming a scribe line on a surface of a brittle material, the scribing apparatus comprising:

a diamond wheel in which diamond grains having 1000 to 8000 mesh are held by a bonding agent;

a holding member for holding the diamond wheel to be rollable;

an oscillation generation member for oscillating the holding member in a direction crossing the surface of the brittle material; and

a moving mechanism for moving the holding member along the surface of the brittle material so that the diamond wheel rolls on the surface of the brittle material.

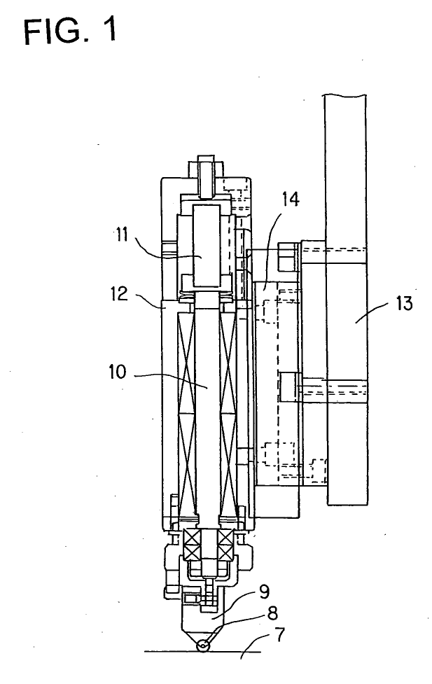

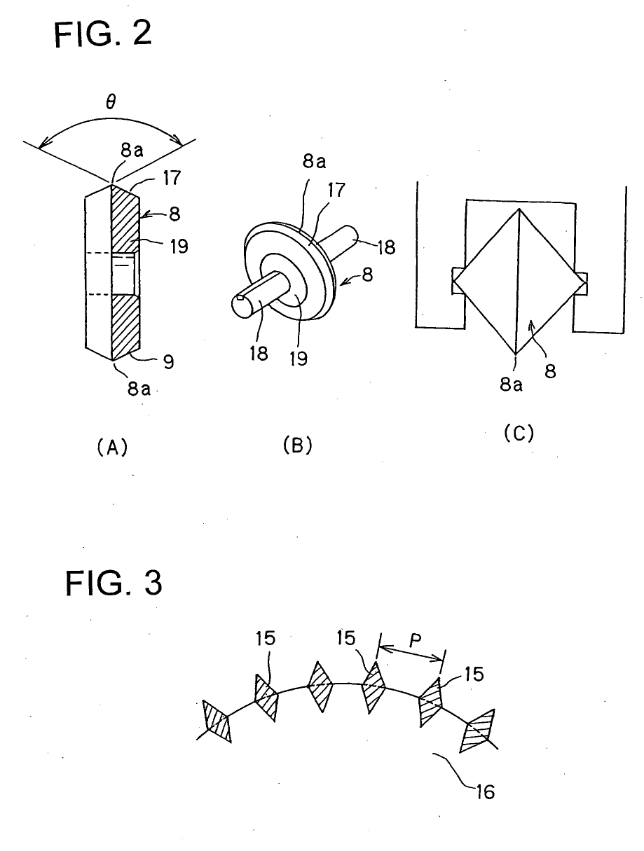

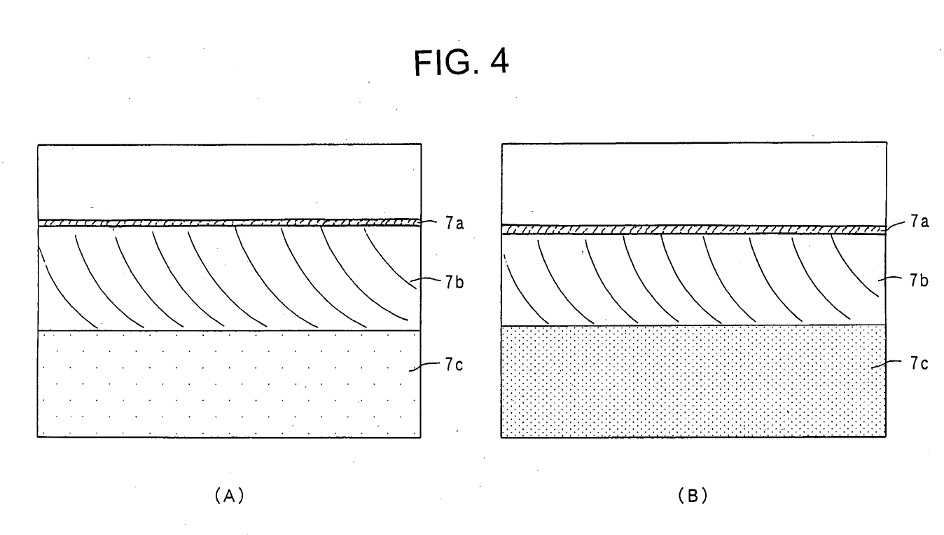

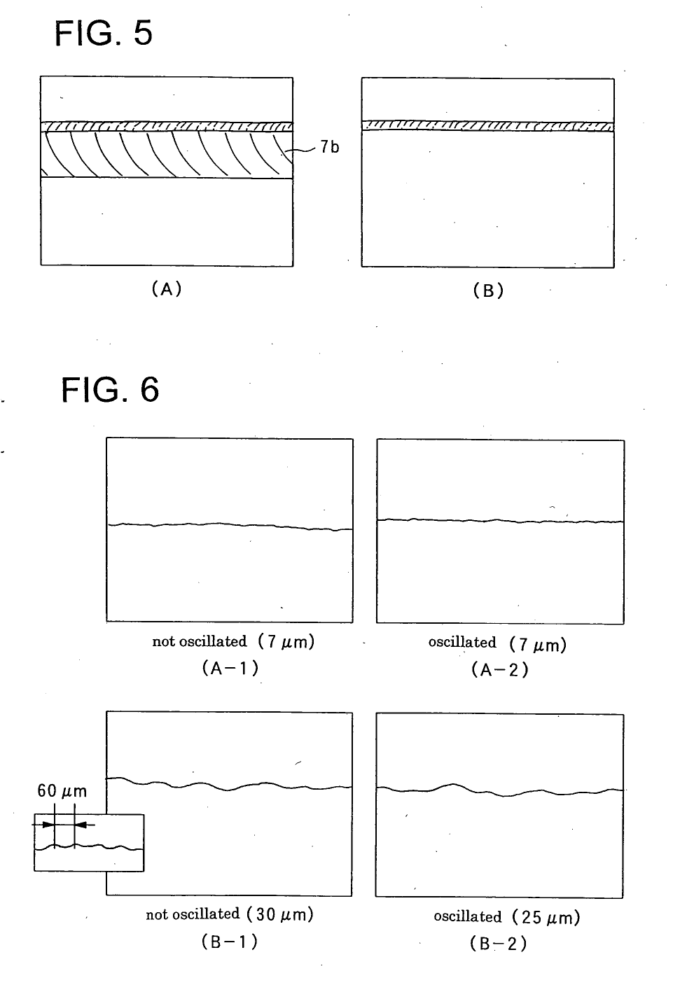

### BRIEF DESCRIPTION OF THE DRAWINGS

[FIG. 1]: Sectional view showing a scribing apparatus according to one embodiment of the present invention.

[FIG. 2]: Detailed views, partially including section, of a diamond wheel.

[FIG. 3]: Schematic view showing projections of diamond grains.

[FIG. 4]: View showing a cut surface of glass.

[FIG. 5]: View showing a cut surface of glass.

[FIG. 6]: View showing a cut surface of glass.

[FIG. 7]: Schematic view showing a conventional diamond wheel.

[FIG. 8]: Schematic view showing a conventional diamond wheel.

### EXPLANATION OF REFERENCE NUMERALS

7—brittle material

8—diamond wheel

9—holding member

11—oscillation generation member

15—diamond grain

16—bonding agent

17—blade

### Best Mode for Embodying the Invention

Hereunder, the present invention will be described with reference to the accompanying drawings. FIG. 1 represents a scribing apparatus according to one embodiment of the present invention. This scribing apparatus is one for forming a scribe line on a surface of a brittle material 7, in form of thin plate, formed of, for example, glass, quartz, semiconductor, ceramics or the like. Herein, the scribe line is a crack as continuous vertical cracks formed on the surface of the brittle material 7.

A diamond wheel 8 is held to a lower end portion of a holding member 9 to be rotatable. The holding member 9 is connected to an oscillation generation member 11 generating an oscillation through an intermediate shaft 10. As such oscillation generation member 11, there is used, for example, a piezoelectric element (piezo-actuator) generating a strain by applying an external electric field. When a voltage applied to the piezoelectric element is changed at a predetermined frequency, the piezoelectric element is periodically expanded and contracted. As such oscillation generation member 11, there may be utilized a super-magnetostrictive element which causes a strain to a magnetic member by applying a magnetic field. The oscillation caused by the oscillation generation member 11 is transmitted to the intermediate shaft 10 and the holding member 9, and finally to the diamond wheel 8. The diamond wheel 8 is hence oscillated in a direction, for example, perpendicular direction, normal to the surface of the brittle material 7 by the oscillation generation member 11.

The oscillation generation member 11 and the intermediate shaft 10 are accommodated in a housing 12. The housing 12 is mounted to a base plate 13 by way of a linearly movable guide 14 so as to be vertically slidable. According to such structure, mass of housing 12, holding member 9, intermediate shaft 10 and oscillation generation member 11 is added, as static load, to the brittle material from the diamond wheel 8.

The base plate 13 is moved in an X-axis direction parallel with the surface of the brittle material 7 and a Y-axis direction by a moving mechanism, not shown. When the base plate 13 is moved in parallel with the surface of the brittle material 7, the diamond wheel abutting against the brittle material 7 rolls thereon.

When the diamond wheel 8 rolls, while oscillating, on the surface of the brittle material 7, a scribe line formed as continuous line of vertical cracks on the surface of the brittle material 7. The brittle material 7 formed with such scribe line is dismounted from the scribing apparatus and broken along the scribe line by a breaking apparatus.

FIG. 2 is a detailed view of the diamond wheel 8. In (A) in FIG. 2, there is shown a diamond wheel 8 in form of a bead on an abacus having a central hole, in (B) of FIG. 2, there is shown a diamond wheel in form of a bead on an abacus having a axial pins projecting on both sides thereof, and in (C) in FIG. 2, there is shown a diamond wheel in form of a combined circular cone. In the diamond wheel 8 shown in FIG. 2 (A), a shaft or pin is inserted into the central hole so that the diamond wheel is rotated around the shaft while sliding. In the diamond wheel 8 shown in FIG. 2(B), shafts or pins 18, 18 are rotated, while sliding, with respect to a shaft bearing supporting the shafts 18, 18. In the diamond wheel 8 shown in FIG. 2(C), tops of the cones are supported by a support frame and rotated, while sliding, with respect to the support frame.

The diamond wheel 8 is formed with an abrasive grain layer 8a which carries diamond abrasive grains with a bonding agent around a metallic rootstock 19 thereof. Resin or metal bond is utilized as boding agent. After adhering the diamond grains to the resin or metal bond, it is pressurized or sintered to thereby firmly carry the diamond grians to the resin or metal bond. As such bonding agent, other than the above resin or metal bonder, a composite bonding material of resin and metal may be utilized. Further, as such diamond grain, an abrasive grain of 1000-8000 mesh (abrasive grains having grain diameter of 1 to 10 μm) will be utilized. The diamond grains may be composed of only abrasive grains of 1000 to 8000 mesh or mixture composed of such diamond grains and diamond powders over 8000 mesh. The diamond wheel 8 having a diameter of, for example, 2 to 8φ may be utilized. Furthermore, the metallic rootstock may be eliminated and the diamond wheel 8 may be hence formed entirely of abrasive grain layer.

Both the sides of the edge portions of the periphery of the disc of the diamond wheel 8 are cut in along the entire periphery thereof so as to form a blade (edge) portion 17 having a V-shape section having a V-shaped opening angle θ ranging in 100 to 165 degrees.

FIG. 3 is a schematic view showing projections of the diamond grains 15, 15,—at the front end edge of the V-shaped blade portion 17. Since the abrasive grains having average grain diameter of 1 to 10 μm is utilized as mentioned above, the projecting amount (distance) of the diamond grain over the bonding agent 16 is large in comparison with that of the conventional average grain diameter of 0.1 to 0.8 μm. The pitch P of the diamond grains 15, 15,—at the front end edge of the V-shaped blade portion 17 is set to be 2 to 20 μm.

By using the diamond grains 15 each having a diameter mentioned above, the diamond grains 15 projecting from the bonding agent 16 is liable to easily bite the brittle material 7. For this reason, the diamond wheel 8 can roll, without sliding, on the brittle material 7 without applying a load of an amount not more than necessary and making large the setting of the notches. In addition, a stress to be applied to the brittle material 7 from the diamond wheel 8 is a strain concentrated in accordance with the size of the diamond grains 15, 15,—projecting from the bonding agent 16, and hence, a deep vertical crack is generated.

The inventor of the subject application confirmed that according to the present invention, the diamond wheel can roll, without sliding, on the surface of the brittle material and a scribe line is formed thereon in good condition even if a small load was applied, a notch was set to be small and driving speed of diamond wheel was set to be fast in comparison with a conventional diamond wheel having an average abrasive grain diameter of 0.1 to 0.8 μm.

Incidentally, in electron device parts or components in an LCD industrial field and the like, it is often to form a coat film having a thickness of 0.1 to 0.5 μm of polarizing plate, protective layer, metal evaporation film or the like on the surface of the brittle material. By setting the diameter of the diamond grain 15 to the value mentioned above, the diamond grains 15 projecting from the bonding agent 16 can easily penetrate such coat film without peeling off the surface layer film due to application of pressure and stick the surface of the brittle material as base substrate. Accordingly, a scribe line can be formed even on the brittle material on which a metal evaporation film is deposited.

Since the strength of the diamond wheel increases as concentration of the diamond grains 15, 15,—increases more and more, it is desired to increase the concentration of the diamond grains 15, 15,—more and more. However, in general, as the grain diameter of the diamond grains 15, 15,—increases, it becomes difficult to make high the concentration thereof In the case of using the diamond wheel 8 of the present invention, it becomes possible to make small a load to be applied to the diamond wheel 8, so that useful life time of the diamond wheel 8 can be protected from making short.

Further, in the described embodiment, although the scribe line is formed while oscillating the diamond wheel, a scribe line may be formed in good condition without oscillating the diamond wheel in such a case where the scribe line is formed in a soft brittle material.

FIG. 4 is a sectional view, in an enlarged scale, showing a cut surface of a glass on which the scribe line was formed and then cut therealong. The glass is formed of a non-alkaline hard material. The cut surface includes three layers consisting of a push-in/come-off layer 7a, a surface crack portion 7b and a smooth crack surface 7c. The push-in/come-off layer 7 formed as the most front surface layer is formed due to horizontal cracks or micro-cracks. The surface crack portion 7b is formed below the push-in/come-off layer 7a, the surface crack portion 7b being called “rib-mark” as continuous surface cracks (i.e., vertical cracks). When the surface cracks propagate in the glass plate thickness direction and penetrate it in the thickness direction, the glass plate is cut off. The portion to which the cracks are propagated is called “smooth crack surface” 7c.

FIG. 4(A) represents an example of the diamond wheel according to the present invention using the diamond grains having the average grain diameter of 2 μm, and FIG. 4(B) represents a comparative example of a diamond wheel using the diamond grains having the average grain diameter of 0.2 μm. In each of these examples, an oscillation is applied to the diamond wheel.

It was found that in the case of cutting the glass plate by using the diamond wheel of the example of the present invention, in comparison with the case of the comparative example, the push-in/come-off layer 7a on the surface of the glass plate was made thin due to the horizontal cracks or micro-cracks, and the deep surface-layer crack portion 7b was formed to the glass plate. Moreover, according to the example of the present invention, there is less difference in light reflection at a boundary between the surface-layer crack portion 7b and the smooth crack surface 7c, so that it was found that the diamond wheel of the present invention is less deflected.

According to the above facts, the blade of the diamond wheel can cut a corundum type brittle material such as quartz or liquid-crystal including hard glass which was not cut in the conventional technology in which the mesh-type was relied on load.

FIG. 5 includes an example (FIG. 5(A)) of the present invention in which glass consisting of a soda-type soft material is cut by a diamond wheel having the average grain diameter of 2 μm, and a comparative example (FIG. 5(B)) of diamond grains having the average grain diameter of 0.2 μm. In the example of the soft material glass, the diamond grains bite the glass surface without oscillating the diamond wheel, so that the diamond wheel is not oscillated in each of these examples. In the case of the diamond wheel of the example according to the present invention, the rib mark 7b is formed only by the biting of the diamond grains to the glass surface. On the other hand, in the case of the diamond wheel according to the comparative example, any rib mark is not formed.

FIG. 6 includes a case in which the diamond wheel according to the present invention was used for cutting the glass ((A-1) and (A-2) in FIG. 6), and a case in which the diamond wheel described in the conventional Patent Publication 1 was used for cutting the glass ((B-1) and (B-2)). In the cases of (A-1) and (B-1), the diamond wheels were not oscillated, and on the other hand, in the cases of (A-2) and (B-2), the diamond wheels were oscillated.

In the case of cutting the glass by using the diamond wheel of the present invention, difference between the recessed portion and the protruded portion on the glass surface was 7 μm even in the case of no oscillation. On the contrary, in the case of cutting the glass by using the diamond wheel disclosed in the Patent Publication 1, difference between the recessed portion and the protruded portion on the glass surface was 30 μm in the case of no oscillation, and was 25 μm, on the other hand, in the case of being oscillated. Further, in the case of the diamond wheel disclosed in the Patent Publication 1, the irregularity (protrusion and recess) was continuously formed in accordance with the cut pitch (60 μm in this example) was formed.

Furthermore, it is to be noted that the various changes and modifications of the embodiments of the present invention mentioned above will be usable for embodying the invention. Thus, the patent claims of the present invention are ones for defining scopes of the invention, and structure and equivalent matters included in the claims should be embraced therein.

The entire disclosure of each of Japanese Patent Application No. 2003-167236 filed on Jun. 12, 2003 including the specification, claims, drawings and summary is incorporated herein by reference in its entirety.

1. A diamond wheel for forming a scribe line on a surface of a brittle material while rolling thereon, wherein diamond grains having 1000 to 8000 mesh are held by a bonding agent.

2. The diamond wheel according to claim 1, wherein a blade having a V-section is formed in an entire circumferential direction of a peripheral edge portion of the diamond wheel, a pitch of the diamond grains at a front end edge of the V-shaped blade in the circumferential direction is set to be 2 to 20 μm.

3. The diamond wheel according to claim 2, wherein the V-shaped section has an opening angle of 110 to 165 degrees.

4. The diamond wheel according to any one of claims 1 to 3, wherein the diamond wheel rolls. on the brittle material while oscillating in a direction crossing the surface of the brittle material.

5. A scribing apparatus for forming a scribe line on a surface of a brittle material, comprising:
a diamond wheel in which diamond grains having 1000 to 8000 mesh are held by a bonding agent;
a holding member for holding the diamond wheel to be rollable;
an oscillation generation member for oscillating the holding member in a direction crossing the surface of the brittle material; and
a moving mechanism for moving the holding member along the surface of the brittle material so that the diamond wheel rolls on the surface of the brittle material.
